(19) United States
(12) Patent Application Publication
(10) Pub. No.: US 2026/0088514 A1
(43) Pub. Date: Mar. 26, 2026

(54) ANTENNA UNIT, ANTENNA APPARATUS AND ELECTRONIC DEVICE

(71) Applicants: Shanghai Tianma Microelectronics Co., Ltd., Shanghai (CN); Chengdu Tianma Microelectronics Co., Ltd., Chengdu (CN)

(72) Inventors: Yifan XING, Shanghai (CN); Yifan BAO, Shanghai (CN); Baiquan LIN, Shanghai (CN); Xiaonan HAN, Shanghai (CN); Taohua CHEN, Shanghai (CN); Xin XU, Shanghai (CN); Yingru HU, Shanghai (CN); Jiayun CHEN, Shanghai (CN); Linzhi WANG, Shanghai (CN); Kerui Xl, Shanghai (CN); Xuhui PENG, Shanghai (CN); Jiaxian LIU, Shanghai (CN)

(73) Assignees: Shanghai Tianma Microelectronics Co., Ltd., Shanghai (CN); Chengdu Tianma Microelectronics Co., Ltd., Chengdu (CN)

(21) Appl. No.: 19/014,266

(22) Filed: Jan. 9, 2025

(30) Foreign Application Priority Data
Sep. 26, 2024 (CN) 202411358660.7

(51) Int. Cl. H01Q 15/00; H01Q 3/30; H01Q 5/307

(52) U.S. Cl. CPC H01Q 15/0086; H01Q 3/30; H01Q 5/307

(57) ABSTRACT

The present application relates to an antenna unit, an antenna apparatus and an electronic device. The antenna unit includes a first substrate, a second substrate and a liquid crystal layer. The first substrate includes a first base, a feeding unit and a first electrode. The feeding unit and the first electrode are disposed at two opposite sides of the first base, and along a direction perpendicular to a plane where the first substrate is located, the feeding unit at least partially overlaps the first electrode. The second substrate includes a second base, a radiation unit and a second electrode, the second electrode is located at a side of the second base facing the first substrate, the second electrode is electrically connected to a ground signal end, the radiation unit is disposed on the second base, and the radiation unit is insulated from the second electrode.

### CROSS-REFERENCE TO RELATED APPLICATIONS

This application claims priority to Chinese Patent Application No. 202411358660.7, titled “ANTENNA UNIT, ANTENNA APPARATUS AND ELECTRONIC DEVICE” and filed on Sep. 26, 2024, which is hereby incorporated by reference in its entirety.

### TECHNICAL FIELD

The present application relates to the field of electromagnetic wave technology, and particularly to an antenna unit, an antenna apparatus and an electronic device.

### BACKGROUND

Based on the anisotropic characteristics of liquid crystal molecules, an electric signal is used by a liquid crystal antenna to control the arrangement of the liquid crystal molecules, so that the dielectric parameters of the radio frequency signals of each phase shifter unit are changed, thereby controlling a phase of the radio frequency signals in each unit, and eventually controlling a radiation beam direction of the antenna. The liquid crystal antenna may be applied to satellite communication, 5G millimeter wave base station and other scenarios.

At present, how to improve coupling efficiency of the radio frequency signals is one of the important factors to improve the performance of the liquid crystal antenna.

### SUMMARY

An antenna unit, an antenna apparatus and an electronic device according to embodiments of the present application can effectively improve coupling efficiency of a radio frequency signal and improve performance of the antenna unit.

In a first aspect, an antenna unit is proposed according to the embodiments of the present application. The antenna unit includes a first substrate, a second substrate and a liquid crystal layer. The first substrate includes a first base, a feeding unit and a first electrode. The feeding unit and the first electrode are provided at two opposite sides of the first base, the feeding unit is electrically connected to a radio frequency signal end, the first electrode is electrically connected to a control signal line, and along a direction perpendicular to a plane where the first substrate is located, the feeding unit at least partially overlaps the first electrode. The second substrate includes a second base, a radiation unit and a second electrode, the second electrode is located at a side of the second base facing the first substrate, the second electrode is electrically connected to a ground signal end, the radiation unit is provided on the second base, and the radiation unit is insulated from the second electrode. Along the direction perpendicular to the plane where the first substrate is located, the first electrode overlaps the radiation unit and the second electrode respectively. A liquid crystal layer is located between the first substrate and the second substrate.

In a second aspect, the embodiments of the present application further provide an antenna apparatus including the previously described antenna unit.

In a third aspect, the embodiments of the present application further provide an electronic device including the previously described antenna apparatus.

### BRIEF DESCRIPTION OF THE DRAWINGS

Features, advantages, and technical effects of exemplary embodiments of the present application will be described below with reference to the drawings.

FIG. 1 is a schematic structural diagram of a top view of an antenna unit according to some embodiments of the present application;

FIG. 2 is a schematic cross-sectional structural view of A-A in FIG. 1;

FIG. 3 is another schematic cross-sectional structural view of A-A in FIG. 1;

FIG. 4 is another schematic cross-sectional structural view of A-A in FIG. 1;

FIG. 5 is another schematic cross-sectional structural view of A-A in FIG. 1;

FIG. 6 is another schematic cross-sectional structural view of A-A in FIG. 1;

FIG. 7 is another schematic cross-sectional structural view of A-A in FIG. 1;

FIG. 8 is another schematic cross-sectional structural view of A-A in FIG. 1;

FIG. 9 is another schematic structural diagram of a top view of the antenna unit according to some embodiments of the present application;

FIG. 10 is another schematic structural diagram of a top view of the antenna unit according to some embodiments of the present application;

FIG. 11 is another schematic structural diagram of a top view of the antenna unit according to some embodiments of the present application;

FIG. 12 is another schematic structural diagram of a top view of the antenna unit according to some embodiments of the present application;

FIG. 13 is another schematic cross-sectional structural view of A-A in FIG. 1; and

FIG. 14 is a schematic structural diagram of an antenna apparatus according to some embodiments of the present application.

### REFERENCE NUMERALS

100: Antenna unit; 200, Antenna apparatus;

10: First substrate; 11: First base; 12: Feeding unit; 121: Feeding layer; 122: Shielding layer; 1221: Main body portion; 1222: Protruding portion; 123: Fourth base; 13: First electrode; 131: First sub-electrode; 132: Second sub-electrode;

20: Second substrate; 21: Second base; 22: Radiation unit; 221: Third base; 222: Radiation body; 23: Second electrode;

30: Liquid crystal layer; 31: Liquid crystal; 32: Encapsulation portion; 33: Conductive portion; 34: Ground portion; 341: First layer structure; 342: Second layer structure; 35: Support portion;

40: First adhesion layer; 41: First adhesion portion; 50: Second adhesion layer; 51: Second adhesion portion; 60: Feeding line; 70: Control signal line; 80: Liquid crystal driving circuit; K1: First opening; K2: Second opening; P: Phase shifting unit; S1: First gap; S2: Second gap;

X: First direction; Y: Second direction; Z: Direction perpendicular to a plane where the first substrate is located.

In the drawings, the same reference numerals represent the same components. The drawings are not drawn to actual scale.

### DETAILED DESCRIPTION

Features and exemplary embodiments of various aspects of the present application will be described in detail below. In order to make the objects, technical solutions and advantages of the present application clearer, the present application is further described in detail below with reference to the drawings and specific embodiments. It should be understood that the specific embodiments described herein are merely intended to explain the present application, rather than to limit the present application. For those skilled in the art, the present application can be implemented without some of these specific details. The following description of the embodiments is only to provide a better understanding of the present application by illustrating examples of the present application.

It should be noted that, in the present application, the relational terms, such as first and second, are used merely to distinguish one entity or operation from another entity or operation, without necessarily requiring or implying any actual such relationships or orders for these entities or operations. Moreover, the terms “comprise”, “include”, or any other variants thereof, are intended to represent a non-exclusive inclusion, such that a process, method, article or device including a series of elements includes not only those elements, but also other elements that are not explicitly listed or elements inherent to such a process, method, article or device. Without more constraints, the elements following an expression “comprise/include . . . ” do not exclude the existence of additional identical elements in the process, method, article or device that includes the elements.

Optical and electrical characteristics of a liquid crystal material are used by a liquid crystal antenna to achieve a radiation and a reception of a wireless signal. A feeding network is an important part of the liquid crystal antenna and is responsible for coupling a signal generated by an external signal source (such as a microwave signal source or a radio frequency signal source) to an electrode in the liquid crystal antenna, so as to drive an arrangement change of liquid crystal molecules, and achieve a modulation and a radiation of the signal.

In the existing liquid crystal antenna, a liquid crystal layer is provided between the electrode and the feeding network that need to be coupled in the liquid crystal antenna, and the coupling damage to the radio frequency signal by the liquid crystal is relatively great, so that the coupling efficiency of the radio frequency signal is decreased, and the performance of the liquid crystal antenna is reduced.

In view of the above problem, embodiments of the present application provide an antenna unit in a first aspect.

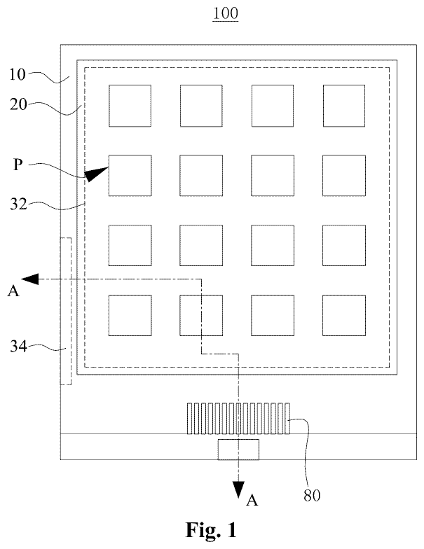

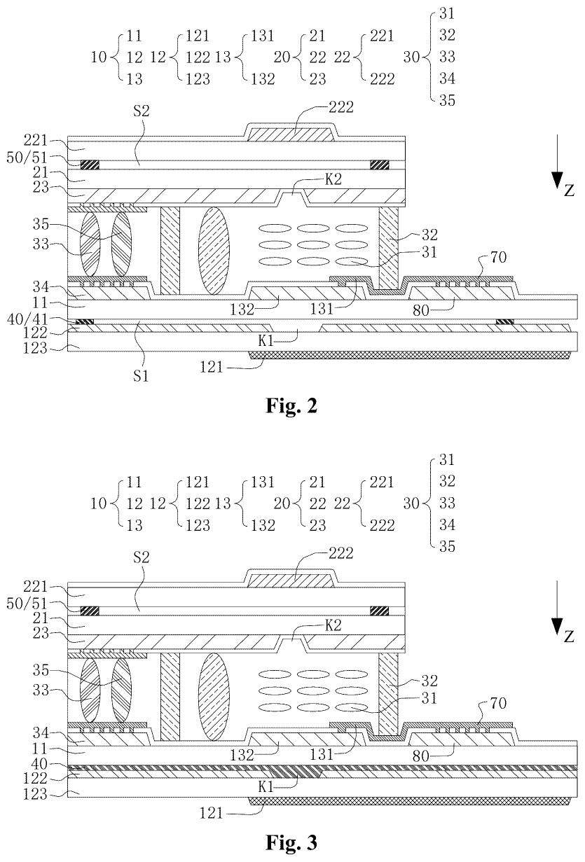

FIG. 1 is a schematic structural diagram of a top view of an antenna unit according to some embodiments of the present application. FIG. 2 is a schematic structural cross-sectional view of A-A in FIG. 1.

As shown in FIG. 1 and FIG. 2, the embodiments of the present application provide an antenna unit 100 including a first substrate 10, a second substrate 20 and a liquid crystal layer 30. The first substrate 10 includes a first base 11, a feeding unit 12 and a first electrode 13. The feeding unit 12 and the first electrode 13 are disposed at two opposite sides of the first base 11, the feeding unit 12 is electrically connected to a radio frequency signal end, the first electrode 13 is electrically connected to a control signal line 70, and along a direction Z perpendicular to a plane where the first substrate is located, the feeding unit 12 at least partially overlaps the first electrode 13. The second substrate 20 includes a second base 21, a radiation unit 22 and a second electrode 23, the second electrode 23 is located at a side of the second base 21 facing the first substrate 10, the second electrode 23 is electrically connected to a ground signal end, the radiation unit 22 is provided on the second base 21, and the radiation unit 22 is insulated from the second electrode 23. Along the direction Z perpendicular to the plane where the first substrate is located, the first electrode 13 overlaps the radiation unit 22 and the second electrode 23, respectively. A liquid crystal layer 30 is located between the first substrate 10 and the second substrate 20.

In some optional embodiments, the first base 11 and the second base 21 of the antenna unit 100 according to the embodiments of the present application may be rigid plates, and, the first base 11 and the second base 21 may be flexible plates respectively in some embodiments.

In some optional embodiments, the first base 11 and the second base 21 may be glass substrates, polyimide (PI) substrates or liquid crystal 31 liquid crystal polymer (LCP) substrates.

The first electrode 13 is electrically connected to the control signal line 70, the second electrode 23 is electrically connected to a ground signal end, an electric field may be formed between the first electrode 13 and the second electrode 23, and a deflection of the liquid crystal 31 may be controlled by the electric field. Optionally, the first electrode 13 is a driving electrode and the second electrode 23 is a ground electrode.

The feeding unit 12 is configured to couple a radio frequency signal transmitted from the radio frequency signal end to the feeding unit 12 to the first electrode 13. The radio frequency signal in the first electrode 13A changes a phase distribution of the radio frequency signal through the deflected liquid crystal 31, and the radio frequency signal with the changed phase distribution is radiated to the radiation unit 22 and then radiated to the outside by the radiation unit 22.

Specifically, a part of the feeding unit 12 overlapping the first electrode 13 may couple the radio frequency signal in the feeding unit 12 to the first electrode 13 through the first base 11, the control signal line 70 provides the control signal to the first electrode 13, and the liquid crystal 31 is deflected by the electric field formed between the first electrode 13 and the second electrode 23, so that a dielectric constant of the liquid crystal 31 is changed, the radio frequency signal in the first electrode 13 is phase-shifted, and the phase-shifted radio frequency signal is radiated by the radiation unit 22. Due to the overlapping of the first electrode 13 with the radiation unit 22, the possibility of the phase-shifted radio frequency signal being lost by other media or even shielded by the second electrode 23 is reduced.

Optionally, the feeding unit 12 is located at a side of the first base 11 away from the second substrate 20, and the first electrode 13 is located at a side of the first base 11 facing the second substrate 20.

Optionally, along the direction Z perpendicular to the plane where the first substrate is located, the feeding unit 12 may overlap the first electrode 13. Alternatively, along the direction Z perpendicular to the plane where the first substrate is located, the feeding unit 12 partially overlaps the first electrode 13. Alternatively, a projection of the feeding unit 12 along the direction Z perpendicular to the plane where the first substrate is located is within a projection of the first electrode 13 along the direction Z perpendicular to the plane where the first substrate is located. Alternatively, the projection of the first electrode 13 along the direction Z perpendicular to the plane where the first substrate is located is within the projection of the feeding unit 12 along the direction Z perpendicular to the plane where the first substrate is located.

The radiation unit 22 can radiate signals and also receive signals, when the radiation unit 22 receives a radio frequency signal, the liquid crystal 31 controls the radio frequency signal to shift the phase. The phase-shifted radio frequency signal is transmitted to the radio frequency signal end via the feeding unit 12 and then outputted via the radio frequency signal end.

Optionally, along the direction Z perpendicular to the plane where the first substrate is located, one part of the first electrode 13 overlaps the radiation unit 22, and the other part of the first electrode 13 overlaps the second electrode 23.

Optionally, the radiation unit 22 may be disposed at the same side of the second base 21 as the second electrode 23, and, the radiation unit 22 may also be disposed at a side of the second base 21 away from the first substrate 10.

Optionally, the radiation unit 22 and the second electrode 23 may be insulated by an insulation layer or the second base 21.

In the antenna unit 100 according to the present application, the feeding unit 12 and the first electrode 13 are provided on the first substrate 10, so that a signal transmission path between the feeding unit 12 and the first electrode 13 can be shortened effectively, and the number of media (such as the second base, a liquid crystal, and the like) through which the radio frequency signal passes can be reduced, thereby reducing a loss of the radio frequency signal coupled from the feeding unit 12 to the first electrode 13 caused by the media between the feeding unit 12 and the first electrode 13, improving the coupling efficiency of the antenna unit 100, and improving the performance of the antenna unit 100.

FIG. 3 is another schematic cross-sectional structural view of A-A in FIG. 1.

As shown in FIG. 2 and FIG. 3, in some optional embodiments, the feeding unit 12 is connected to the first base 11 by a first adhesion layer 40.

Optionally, a material of the first adhesion layer 40 includes Optically Clear Adhesive (OCA) or Optical Clear Resin (OCR).

In the embodiments of the present application, the feeding unit 12 is connected to the first base 11 by the first adhesion layer 40, which is conducive to reducing the difficulty of connecting the feeding unit 12 to the first base 11, improving a manufacturing yield of the feeding unit 12 and the first base 11, and improving the production efficiency.

As shown in FIG. 2, in some optional embodiments, the first adhesion layer 40 includes a plurality of first adhesion portions 41 disposed at intervals, and along the direction Z perpendicular to the plane where the first substrate is located, the first adhesion portion 41 is spaced apart from an overlapping area of the feeding unit 12 and the first electrode 13.

The feeding unit 12 and the first electrode 13 have the overlapping area, and a projection of the first adhesion portion 41 along the direction Z perpendicular to the plane where the first substrate is located is spaced apart from a projection of the overlapping area along the direction Z perpendicular to the plane where the first substrate is located.

In these optional embodiments, a first gap S1 is disposed between two of first adhesion portions 41, so that the first gap S1 exists on the first adhesion layer 40 at the signal transmission path, and the signal transmission path does not overlap the first adhesion portion 41, which can effectively reduce a transmission loss of the radio frequency signal in the medium, thereby improving the coupling efficiency of the radio frequency signal, and improving the performance of the antenna unit 100.

As shown in FIG. 3, in some optional embodiments, the first adhesion layer 40 entirely covers the feeding unit 12.

Optionally, the first adhesion layer 40 is a complete film layer, and the first adhesion layer 40 fills a space between the feeding unit 12 and the first base 11 to add an area for the first adhesion layer 40 to support the first base 11, thereby reducing a possibility that the first base 11 and a film layer at a side of the first base 11 away from the first adhesion layer 40 are partially recessed, and improving an overall flatness of the antenna unit.

As shown in FIG. 2 and FIG. 3, in some optional embodiments, the radiation unit 22 is located at the side of the second base 21 away from the first substrate 10, the radiation unit 22 includes a radiation body 222 and a third base 221, the radiation body 222 is located at a side of the third base 221 away from the second base 21, and the third base 221 is connected to the second base 21 by the second adhesion layer 50.

Optionally, a material of the third base 221 may be the same as a material of the second base 21. The material of the third base 221 may be different from the material of the second base 21. Optionally, an area of the third base 221 may be the same as an area of the second base 21.

Optionally, the radiation body 222 may be a conductive film layer provided on the third base 221.

Optionally, along the direction perpendicular to the plane where the first substrate 10 is located, the radiation body 222 at least partially overlaps the first electrode 13.

Optionally, a material of the second adhesion layer 50 may be the same as, or, may be different from, a material of the first adhesion layer 40.

In these optional embodiments, the above arrangement is conducive to reducing a possibility of a short circuit between the radiation body 222 and the second electrode 23, manufacturing the conductive film layer (the second electrode 23) at a side of the second base 21 and adhering another conductive film layer (the radiation body 222) by an adhesion process, which is conducive to reducing a process difficulty for manufacturing the conductive film layer on the second base 21, reducing a manufacturing cost and improving a production yield.

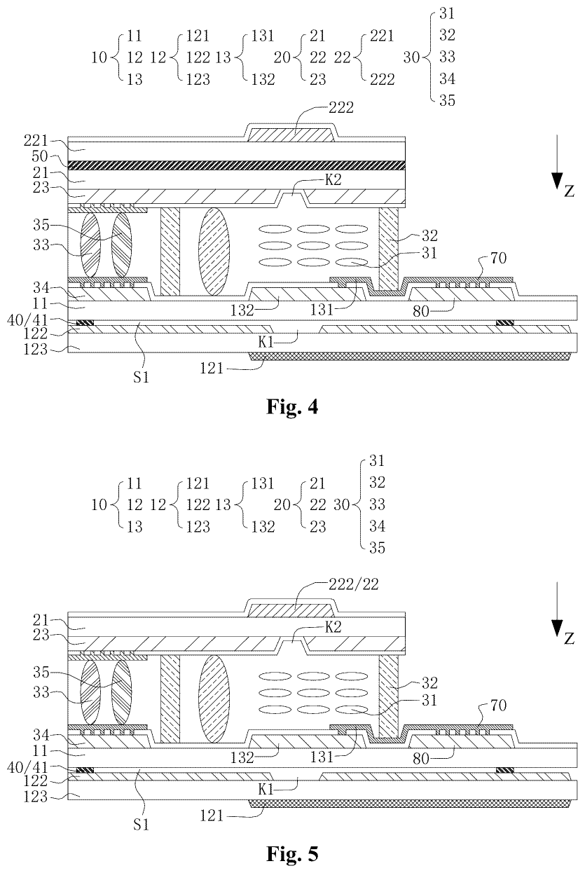

FIG. 4 is another schematic cross-sectional structural view of A-A in FIG. 1.

As shown in FIG. 4, in some optional embodiments, the second adhesion layer 50 entirely covers the second base 21.

Optionally, the second adhesion layer 50 is a complete film layer, and the second adhesion layer 50 fills a space between the second base 21 and the third base 221 to add an area for the second adhesion layer 50 to support the third base 221, thereby reducing a possibility that the third base 221 and a film layer at a side of the third base 221 away from the second adhesion layer 50 are partially recessed, and improving the overall flatness of the antenna unit.

As shown in FIG. 2 and FIG. 3, in some optional embodiments, the second adhesion layer 50 includes a plurality of second adhesion portions 51 disposed at intervals, and along the direction Z perpendicular to the plane where the first substrate is located, the second adhesion portion 51 is spaced apart from the radiation body 222.

The radiation body 222 and the first electrode 13 have an overlapping area, and a projection of the second adhesion portion 51 along the direction Z perpendicular to the plane where the first substrate is located is spaced apart from the projection of the overlapping area along the direction Z perpendicular to the plane where the first substrate is located.

In these optional embodiments, a second gap S2 is disposed between two of the second adhesion portions 51, so that the second gap S2 exists on the second adhesion layer 50 at the signal transmission path, and the signal transmission path does not overlap the second adhesion portion 51, which can effectively reduce the transmission loss of the radio frequency signal in the medium, thereby improving the coupling efficiency of the radio frequency signal, and improving the performance of the antenna unit 100.

FIG. 5 is another schematic cross-sectional structural view of A-A in FIG. 1.

As shown in FIG. 5, in some optional embodiments, the radiation unit 22 includes the radiation body 222, and the radiation body is disposed at the side of the second base 21 away from the first substrate 10.

In these optional embodiments, the second electrode 23 is disposed at the side of the second base 21 facing the first substrate 10, and the radiation body 222 is disposed at the side of the second base 21 away from the first substrate 10, so that an overall thickness of the second substrate 20 is reduced, so as to reduce an overall thickness of the antenna unit 100, which is conducive to facilitating miniaturization and microminiaturization of the antenna unit 100.

As shown in FIG. 2 to FIG. 5, in some optional embodiments, the feeding unit 12 includes a feeding layer 121, a shielding layer 122 and a fourth base 123 located between the feeding layer 121 and the shielding layer 122, the shielding layer 122 is electrically connected to the ground signal end, and the shielding layer 122 is provided with a first opening K1. Along the direction Z perpendicular to the plane where the first substrate is located, the first opening K1, the feeding layer 121 and the first electrode 13 at least partially overlap with one another.

Optionally, the feeding layer 121 may include a feeding circuit, and the feeding circuit may be formed at a side of the fourth base 123 away from the second substrate 20 by etching.

Optionally, a material of the fourth base 123 may be the same as, or, may be different from, a material of the first base 11.

Optionally, the material of the fourth base 123 includes a flexible circuit board and a glass substrate.

Optionally, the shielding layer 122 is grounded to the ground signal end, and the shielding layer 122 and the second electrode 23 may be connected to the same ground signal end, or, may be connected to different ground signal ends.

The shielding layer 122 may be used for shielding signals, for example, the radio frequency signals of the feeding layer 121 coupled to the first electrode 13 need to be phase-shifted, a part of the phase-shifted radio frequency signals may move toward the feeding layer 121, and the shielding layer 122 can block the phase-shifted radio frequency signals, so that mutual crosstalk of the signals are avoided.

Optionally, the first opening K1 provided on the shielding layer 122 may serve as a coupling channel for the radio frequency signal. Along the direction Z perpendicular to the plane where the first substrate is located, the first opening K1 at least partially overlaps the feeding layer 121, and the first opening K1 at least partially overlaps the first electrode 13. It should be noted that, an overlapping part of the feeding layer 121 and the first opening K1 overlaps an overlapping part of the first opening K1 and the first electrode 13, for example, the overlapping part of the feeding layer 121 and the first opening K1 is a first overlapping portion of the feeding layer 121, the overlapping part of the first opening K1 and the first electrode 13 is a second overlapping portion of the first electrode 13, and along the direction Z perpendicular to the plane where the first substrate is located, the first overlapping portion overlaps the second overlapping portion. Optionally, an end portion of the feeding network in the feeding layer 121 overlaps the first opening K1. Optionally, an end portion of the first electrode 13 overlaps the first opening K1.

As shown in FIG. 2 to FIG. 5, in some optional embodiments, the radiation unit 22 is disposed at the side of the second base 21 away from the first substrate 10, the radiation unit 22 includes the radiation body 222, the second electrode 23 is provided with a second opening K2, and along the direction Z perpendicular to the plane where the first substrate is located, the second opening K2, the radiation body 222 and the first electrode 13 at least partially overlap with one another.

Optionally, a projection of the second opening K2 along the direction Z perpendicular to the plane where the first substrate is located may fall within a projection of the radiation body 222 along the direction Z perpendicular to the plane where the first substrate is located. Alternatively, along the direction Z perpendicular to the plane where the first substrate is located, the second opening K2 overlaps the radiation body 222. Alternatively, along the direction Z perpendicular to the plane where the first substrate is located, the radiation body 222 overlaps the overlapping portion.

The second electrode 23 is electrically connected to the ground signal end, so that the second electrode 23 is the ground electrode, the second electrode 23 may be used for shielding the signals, and the phase-shifted radio frequency signal may be radiated to the radiation body 222 only through the second opening K2, thereby reducing the possibility of interference between the dissipation of the phase-shifted radio frequency signal and the signal radiated from the radiation body 222 with each other.

Optionally, the second opening K2 provided on the second electrode 23 may serve as a radiation channel for the radio frequency signal. Along the direction Z perpendicular to the plane where the first substrate is located, the second opening K2 at least partially overlaps the radiation body 222, and the second opening K2 at least partially overlaps the second electrode 23. It should be noted that, an overlapping part of the radiation body 222 and the second opening K2 overlaps an overlapping part of the second opening K2 and the second electrode 23, for example, the overlapping part of the radiation body 222 and the second opening K2 is a third overlapping portion of the radiation body 222, the overlapping part of the second opening K2 and the second electrode 23 is a fourth overlapping portion of the second electrode 23, and along the direction Z perpendicular to the plane where the first substrate is located, the third overlapping portion overlaps the fourth overlapping portion.

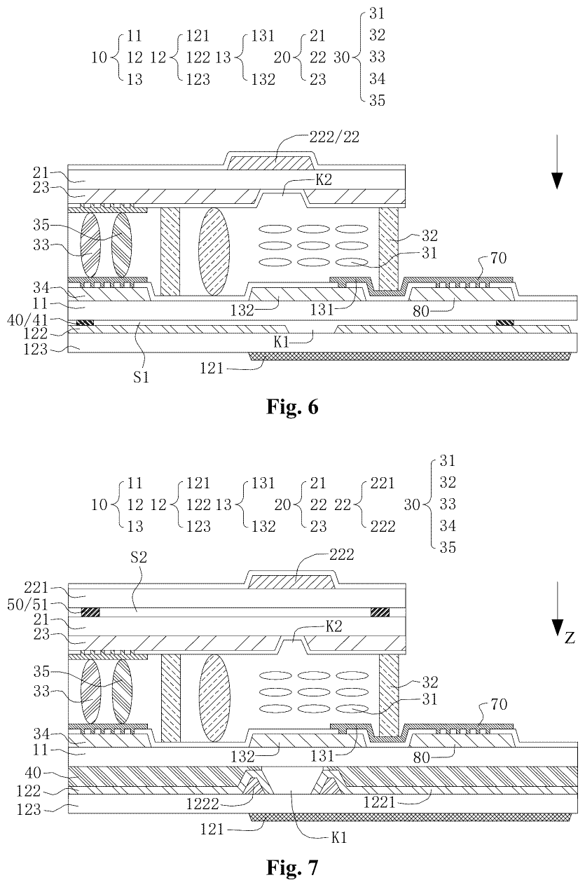

FIG. 6 is another schematic cross-sectional structural view of A-A in FIG. 1.

As shown in FIG. 5 and FIG. 6, in some optional embodiments, along the direction Z perpendicular to the plane where the first substrate is located, the first opening K1 at least partially overlaps the second opening K2.

In some embodiments, along the direction Z perpendicular to the plane where the first substrate is located, a part of the first opening K1 overlaps a part of the second opening K2. In some other embodiments, along the direction Z perpendicular to the plane where the first substrate is located, the first opening K1 is located within the second opening K2.

In these optional embodiments, through the above arrangement, the first opening K1 and the second opening K2 are disposed oppositely along the direction Z perpendicular to the plane where the first substrate is located, so that a phase shifting distance of the radio frequency signal is shortened, and an overall volume of the antenna unit 100 is reduced.

As shown in FIG. 5, in some optional embodiments, along the direction Z perpendicular to the plane where the first substrate is located, the second opening K2 is located within the first opening K1.

Exemplarily, an opening area of the first opening K1 is greater than an opening area of the second opening K2.

Optionally, a shape of the first opening K1 may be the same as, or, may be different from, a shape of the second opening K2. For example, the shape of the first opening K1 and the shape of the second opening K2 are both circular, and the first opening K1 and the second opening K2 are concentric circles.

In these optional embodiments, through the above arrangement, it is conducive to reducing an alignment accuracy of the first opening K1 and the second opening K2, reducing a manufacturing difficulty, and improving the manufacturing yield while reducing a phase shifting accuracy.

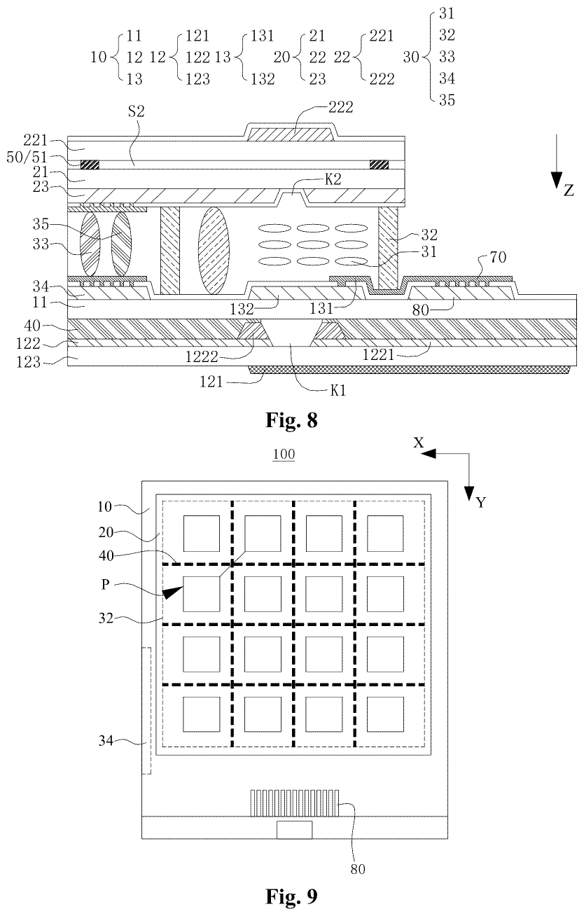

FIG. 7 is another schematic cross-sectional structural view of A-A in FIG. 1. FIG. 8 is another schematic cross-sectional structural view of A-A in FIG. 1.

As shown in FIG. 7 and FIG. 8, in some optional embodiments, the shielding layer 122 includes a main body portion 1221 and a protruding portion 1222, the protruding portion 1222 protrudes from the main body portion 1221 along a direction from the fourth base 123 to the first base 11, the protruding portion 1222 encloses the first opening K1, and the first adhesion layer 40 covers at least the main body portion 1221.

In some embodiments, the first adhesion layer 40 covers the main body portion 1221, so that an overall connection area of the first adhesion layer 40 is increased.

In some embodiments, the protruding portion 1222 and the main body portion 1221 may be an integral structure. In some other embodiments, the protruding portion 1222 and the main body portion 1221 may be separate structures.

Exemplarily, as shown in FIG. 7, an insulation layer may be disposed on the fourth substrate in an area where the protruding portion 1222 is located, so that a part of a shielding portion protrudes from the main body portion 1221 along a direction toward the first substrate 10 to form the protruding portion 1222.

Exemplarily, as shown in FIG. 8, an entire conductive film layer may be provided on the fourth substrate, and the conductive portion 33 may be covered on the conductive film layer, and the conductive film layer covering the conductive portion 33 and the conductive portion may together form the protruding portion 1222. Optionally, materials of the conductive portion 33 and the conductive film layer may be different.

In these optional embodiments, the first adhesion portion 41 covers the main body portion 1221, which is conducive to increasing a connection area between the first base 11 and the fourth base 123. The protruding portion 1222 is provided, which is conducive to reducing a possibility of the first adhesion portion 41 entering into the first opening K1 in the manufacturing process, so that the radio frequency signal coupled from the feeding layer 121 to the first electrode 13 passes only through the first gap S1 when passing through the film layer where the first adhesion layer 40 is located, thereby reducing the loss of the radio frequency signal, improving the coupling efficiency of the radio frequency signal, and improving reliability of the antenna unit 100.

As shown in FIG. 7 and FIG. 8, in some optional embodiments, a gap is provided between the protruding portion 1222 and the first base 11.

Optionally, the first adhesion layer 40 may be provided within the gap to further increase the connection area between the first base 11 and the fourth base 123. Alternatively, the first adhesion layer 40 may not be provided within the gap, so that the possibility of the first adhesion layer entering the first opening K1 is reduced, and a manufacturing difficulty of the first adhesion layer 40 is reduced.

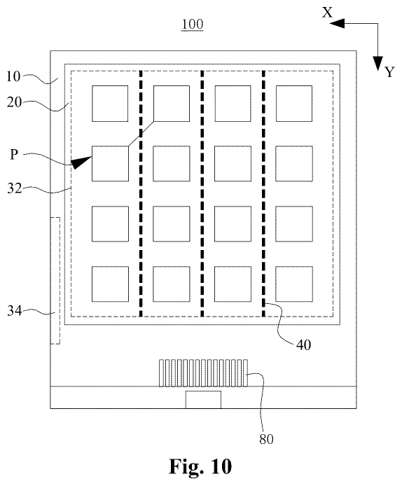

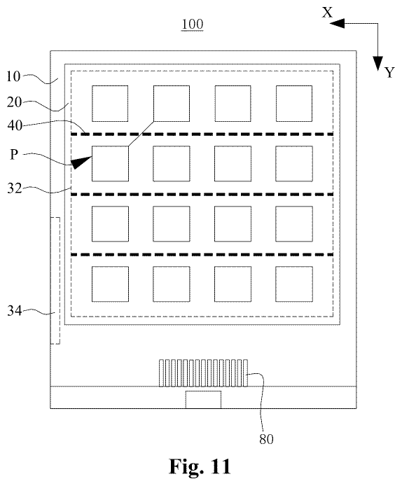

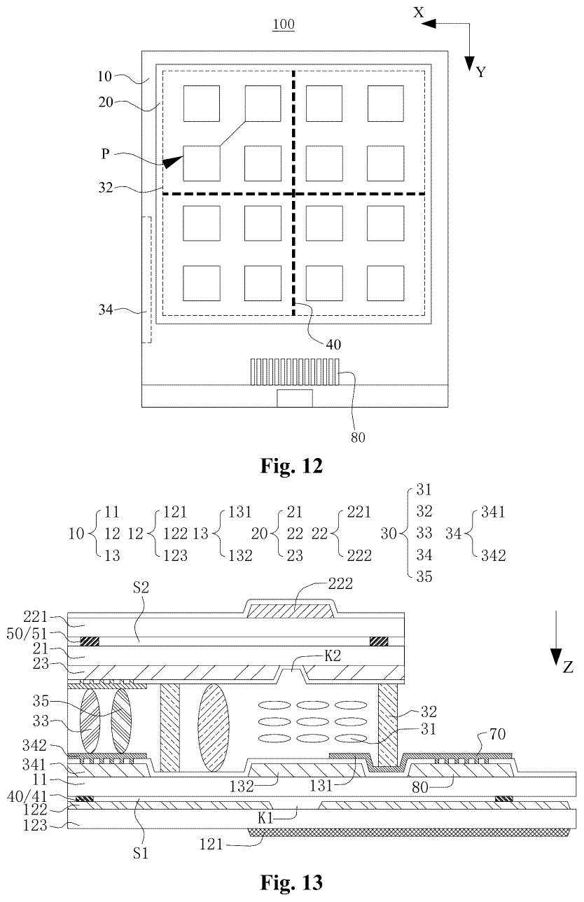

FIG. 9 is another schematic structural diagram of a top view of an antenna unit according to some embodiments of the present application. FIG. 10 is another schematic structural diagram of a top view of an antenna unit according to some embodiments of the present application. FIG. 11 is another schematic structural diagram of a top view of an antenna unit according to some embodiments of the present application. FIG. 12 is another schematic structural diagram of a top view of an antenna unit according to some embodiments of the present application.

As shown in FIG. 9 to FIG. 12, in some optional embodiments, the antenna unit 100 includes a plurality of phase shifting units P arranged in an array, each phase shifting unit includes the feeding unit 12, the first electrode 13, the radiation unit 22, the second electrode 23 and the liquid crystal layer 30, the first adhesion portion 41 is provided between at least a part of adjacent phase shifting units of the plurality of phase shifting units P, and the first adhesion portion is provided between the feeding unit 12 and the first base 11.

A plurality of radio frequency signals radiated by the plurality of phase shifting units P interfere and form a beam having a main lobe direction to meet a performance requirement of the antenna unit 100. For a single phase shifting unit P, the control signal line 70 provides different control signals to the first electrode 13, and after the electric field formed between the first electrode and the second electrode 23 drives the liquid crystal 31 to deflect, the liquid crystal may have different dielectric constants, so that the phase shifting unit P performs different degrees of phase shifting on the radio frequency signals. That is, in the embodiments of the present application, the phase shifting unit P is a phase shifting unit P with a variable control signal voltage, and one phase shifting unit can radiate radio frequency signals with a plurality of phases. As such, phases of the radio frequency signals radiated by the phase shifting units P are adjusted, the main lobe direction of the finally formed beam can be adjusted after the radio frequency signals radiated by the plurality of phase shifting units P interfere with one another.

It may be understood that, each phase shifting unit P includes the feeding unit 12, the first electrode 13, the radiation unit 22, the second electrode 23 and the liquid crystal layer 30, the plurality of phase shifting units P may be formed by splicing, and, the plurality of phase shifting units P may be formed by manufacturing a plurality of feeding units 12, a plurality of first electrodes 13, a plurality of radiation units 22, a plurality of second electrodes 23 and the liquid crystal layer 30 on one first base 11 and one second base 21, respectively. The plurality of second electrodes 23 may be a whole layer structure.

In these optional embodiments, the feeding unit 12 is connected to the first base 11 by the first adhesion portion 41, and the first adhesion portion may support the first base 11 to reduce a possibility that a central area or a partial area of the first base is deformed by gravity under a condition that the plurality of phase shifting units P are manufactured on the same first base 11, so that a risk of a differentiation between a coupled radio frequency signal in a deformed phase shifting unit P and a coupled radio frequency signal in a non-deformed phase shifting unit P is reduced, and service life of the antenna unit 100 is improved.

As shown in FIG. 9 to FIG. 12, in some optional embodiments, the phase shifting units P are arranged in rows along a first direction X and in columns along a second direction Y. Each of the first adhesion portions 41 is provided between two adjacent columns of phase shifting units P, and/or, each of the first adhesion portions 41 is provided between two adjacent rows of phase shifting units P.

In some embodiments, as shown in FIG. 9, each of the first adhesion portions 41 is provided between two adjacent columns of phase shifting units P, and each of the first adhesion portions 41 is provided between two adjacent rows of phase shifting units P, so that a performance consistency of the plurality of phase shifting units P is improved. In some embodiments, as shown in FIG. 10, each of the first adhesion portions 41 is provided between two adjacent columns of phase shifting units P; or, as shown in FIG. 11, each of the first adhesion portions 41 is provided between two adjacent rows of phase shifting units P, so that the antenna unit 100 may improve supporting performance according to a design requirement, for example, the antenna unit 100 may have a relatively strong radiating or receiving capacity along a specific direction. The first adhesion portions 41 may extend along the specific direction.

Optionally, an orthographic projection of the first adhesion portion 41 on the substrate may be in a grid-like shape.

Optionally, the first direction X, the second direction Y and the direction perpendicular to the plane where the substrate is located are perpendicular to each other.

As shown in FIG. 9 to FIG. 12, in some optional embodiments, the first adhesion portions 41 extend along the first direction X, and the plurality of phase shifting units P are provided at two sides of each of the first adhesion portions 41 along the second direction Y, respectively; and/or, the first adhesion portions 41 extend along the second direction Y, and the plurality of phase shifting units P are provided at two sides of each of the first adhesion portions 41 along the first direction X, respectively.

In some embodiments, as shown in FIG. 12, the first adhesion portions 41 extend along the first direction X, so that the first substrate 10 provides a stable support and connection along the first direction. Simultaneously, the plurality of phase shifting units P are provided at two sides of each of the first adhesion portions 41 along the second direction Y, respectively, and such arrangement is conducive to forming a specific radiation and reception pattern along the second direction Y to meet a communication or detection requirement along a specific direction.

In some other embodiments, the first adhesion portions 41 extend along the second direction Y, so that the first substrate 10 provides a stable support and connection along the second direction. Simultaneously, the plurality of phase shifting units P are provided at two sides of each of the first adhesion portions 41 along the first direction X, respectively, and such arrangement achieves an adjustment to the radiation or reception pattern along the first direction, and provides flexibility for different application scenarios.

In some other embodiments, two first adhesion portions 41 are provided, one first adhesion portion 41 extends along the first direction X, and the other first adhesion portion 41 extends along the second direction Y, so that the plurality of phase shifting units P are distributed in four areas divided by the two first adhesion portions 41. Optionally, the plurality of phase shifting units P are symmetrically distributed with respect to a center of an intersection point of the two first adhesion portions 41, which is conducive to improving a support strength of a central area of the first substrate 10, reducing a possibility of a deformation in the central area of the first substrate, and improving the reliability of the antenna unit 100 while increasing the number of the phase shifting units P in the antenna unit 100.

FIG. 13 is another schematic cross-sectional structural view of A-A in FIG. 1.

As shown in FIG. 2 and FIG. 13, in some optional embodiments, the feeding unit 12 includes the feeding layer 121, the radiation unit 22 includes the radiation body 222, the first electrode 13 includes a first sub-electrode 131 and a second sub-electrode 132, the first sub-electrode is electrically connected to the control signal line 70, and along the direction Z perpendicular to the plane where the first substrate is located, the second sub-electrode 132 overlaps the feeding layer 121 and the radiation body 222, respectively.

The first sub-electrode 131 is directly electrically connected to the control signal line 70. The control signal line is responsible for transmitting control signals from an external controller, and these signals are applied to the liquid crystal layer 30 after passing through the first sub-electrode 131, so that a precise control over an arrangement state of liquid crystal molecules is achieved.

Along the direction Z perpendicular to the plane where the first substrate is located, the second sub-electrode 132 overlaps the feeding layer 121 and the radiation body 222, respectively. Such overlapping design enables the second sub-electrode 132 to form a capacitive coupling effect between the feeding layer 121 and the radiation body 222 through the electric field, so that an adjustment to electromagnetic wave radiation characteristics is achieved. Specifically, under a condition that the arrangement state of the molecules of the liquid crystal 31 is changed by the control signal, a capacitance value between the second sub-electrode 132 and the feeding layer 121 as well as the radiation body 222 is also changed, so that the electromagnetic wave characteristics (such as a phase and radiation direction pattern) are affected.

Along the direction Z perpendicular to the plane where the first substrate is located, the second sub-electrode 132 overlaps the feeding layer 121 and the radiation body 222, respectively, which may be understood that, along the direction Z perpendicular to the plane where the first substrate is located, the second sub-electrode 132 overlaps the feeding layer 121, and along the direction Z perpendicular to the plane where the first substrate is located, the second sub-electrode 132 overlaps the radiation body 222. In some embodiments, along the direction Z perpendicular to the plane where the first substrate is located, an overlapping area of the second sub-electrode 132 and the feeding layer 121 may overlap, or, may not overlap, an overlapping area of the second sub-electrode and the radiation body 222. For example, along the direction Z perpendicular to the plane where the first substrate is located, the overlapping area of the second sub-electrode 132 and the feeding layer 121 is a fifth overlapping area, along the direction Z perpendicular to the plane where the first substrate is located, the overlapping area of the second sub-electrode 132 and the radiation body 222 is a sixth overlapping area, and the fifth overlapping area may completely overlap, partially overlap, or not overlap the sixth overlapping area.

As shown in FIG. 2, in some optional embodiments, the first sub-electrode 131 is electrically connected to the second sub-electrode 132.

Exemplarily, the first sub-electrode 131 and the second sub-electrode 132 are electrically connected. Such electrical connection may be achieved through a metal wire, a conductive film layer or other conductive structures, which ensures that the control signal can be transmitted smoothly from the first sub-electrode 131 to the second sub-electrode 132.

Since the first sub-electrode is directly connected to the control signal line 70, under a condition that the external controller generates the control signals, these signals are first received by the first sub-electrode 131 and transferred to the second sub-electrode 132 by the electrical connection. Then, the second sub-electrode interacts with the feeding layer 121 and the radiation body 222 through the electric field to jointly adjust the arrangement state of the molecules of the liquid crystal 31, so that a control over the electromagnetic wave radiation characteristics is achieved.

Such electrical connection design simplifies a transmission path of the control signal and improves reliability and efficiency of the signal transmission. Simultaneously, such electrical connection design also enables the first electrode 13 to respond to an external control signal as a whole, and achieve a more precise and flexible electromagnetic wave radiation control.

Optionally, a material of the first sub-electrode 131 may include indium tin oxide (ITO).

In the embodiments of the present application, through the electrical connection design between the first sub-electrode 131 and the second sub-electrode 132, the efficiency and the reliability of the antenna unit 100 in controlling the signal transmission and adjusting radiation of a video signal may be improved, and the performance of the antenna unit 100 may be further improved.

As shown in FIG. 13, in some optional embodiments, the first sub-electrode 131 is insulated from the second sub-electrode 132, and at least a part of the first sub-electrode 131 is located at a side of a part of the second sub-electrode 132 away from the first base 11.

The first sub-electrode 131 and the second sub-electrode 132 are insulated from each other. The first sub-electrode 131 is insulated from the second sub-electrode 132 by an insulation layer or other insulation structures. Such insulation design ensures electrical independence of the two, reduces current leakage and interference between the two, and ensures stability and reliability of the antenna unit 100.

Along a direction perpendicular to a plane where the first base 11 is located, at least the part of the first sub-electrode 131 is located at the side of the part of the second sub-electrode 132 away from the first base 11. Since electrical signals in the first sub-electrode 131 and the second sub-electrode 132 are different, and the phase shifting needs to be performed on the radio frequency signal in the second sub-electrode by the liquid crystal 31, one part of the second sub-electrode 132 is used for overlapping the feeding layer 121 and the radiation body 222, respectively, and the other part of the second sub-electrode 132 is covered by the first sub-electrode 131, so that an overall size of the first electrode 13 is reduced, and an overall size of the phase shifting unit P is reduced while reducing the current leakage and the interference between the first sub-electrode and the second sub-electrode 132.

It may be understood that, although the first sub-electrode 131 and the second sub-electrode 132 are insulated from each other, they still functionally cooperate with each other through the liquid crystal layer 30 and other related structures. The first sub-electrode 131 receives the control signal from the external controller and influences the arrangement state of the molecules of the liquid crystal 31 through the electric field. The second sub-electrode 132 interacts with the feeding layer 121 and the radiation body 222 to jointly adjust the electromagnetic wave radiation characteristics. Such cooperation enables the antenna of the liquid crystal 31 to achieve a dynamic adjustment to the electromagnetic wave radiation characteristics by changing the control signal under a condition that a physical structure is not changed.

As shown in FIG. 13, in some optional embodiments, the liquid crystal layer 30 includes the liquid crystal and an encapsulation portion 32, the first substrate 10, the second substrate 20 and the encapsulation portion enclose an accommodation space, and the liquid crystal 31 is located within the accommodation space.

The encapsulation portion 32 is an important component of the antenna unit 100, and an encapsulation layer, the first substrate 10 and the second substrate 20 enclose a closed accommodation space, so as to reduce a possibility of a material of the liquid crystal 31 contacting with an external impurity and water vapor, and improve the reliability of the antenna unit 100.

As shown in FIG. 13, in some optional embodiments, the liquid crystal layer 30 further includes the conductive portion 33, and the first substrate 10 further includes a ground portion 34 electrically connected to the ground signal end, the ground portion 34 is located at the side of the first base 11 facing the second substrate 20, and the ground portion is electrically connected to the second electrode 23 by the conductive portion 33.

Optionally, the conductive portion is generally made of a conductive material (such as ITO, a thin metal film, and the like). Exemplarily, the material of the conductive portion 33 includes gold.

Optionally, a surface of the side of the first base 11 facing the second substrate 20 may be provided with the ground portion 34 and the first electrode 13, in the process flow of forming the ground portion and the first electrode, only a layer of metal (such as a layer of copper) needs to be evaporated on the surface of the first base 11, and then the ground portion 34 and the first electrode 13 may be formed by etching using the mask process once, so that the process flow is simplified, and the manufacturing cost is reduced.

Optionally, the surface of the side of the first base 11 facing the second substrate 20 may be provided with the ground portion 34, the first electrode 13, the ground signal end and a driving signal line.

Optionally, the ground portion 34 may include a two-layer structure, a first layer structure 341 and the first sub-electrode 131 are provided in the same layer, a second layer structure 342 is located at a side of the first layer structure 341 away from the first base 11, and the second layer structure 342 and the second sub-electrode 132 are provided in the same layer.

The ground portion 34 is electrically connected to the second electrode 23 by the conductive portion 33, which may be understood in a way that ground potential in the second electrode is provided by the ground portion 34, and the ground signal end is provided on the first base 11, so that process steps may be reduced, and a connection of the second electrode 23 may be simplified.

Electrical performance and stability of the antenna unit 100 are improved by introducing the conductive portion 33 and the ground portion 34 in the embodiments of the present application. The conductive portion 33 provides a reliable electrical connection path between the second electrode 23 and the ground portion 34, and the ground portion ensures that potential of the antenna unit 100 is stable and potential electromagnetic interference is eliminated, so that adaptability of the antenna unit 100 in various complex application scenarios is improved.

As shown in FIG. 13, in some optional embodiments, the liquid crystal layer 30 further includes a support portion 35, and the support portion is located between the ground portion 34 and the second electrode 23.

The support portion is located between the ground portion and the second electrode, and a support structure may play a mechanical supporting role to prevent the liquid crystal layer 30 from being deformed or damaged under a condition that the liquid crystal layer 30 is subjected to external pressure or vibration. The support portion 35 also helps to maintain a uniform thickness and a shape of the liquid crystal layer 30, thereby ensuring that the liquid crystal molecules can operate in a stable environment. Simultaneously, the support portion 35 further helps to distribute the pressure applied to the conductive portion 33, thereby reducing a possibility that potential of the second electrode 23 is changed due to deformation of the conductive portion by an external force, and improving the reliability of the antenna unit 100.

The support portion 35 is generally made of materials having good mechanical properties and chemical stability, such as polymer, glass microbeads, inorganic particles, or the like. These materials have sufficient strength and hardness to support the liquid crystal layer 30, and maintain good compatibility with the liquid crystal material and an encapsulation material, so that a chemical reaction or affecting performance of the liquid crystal 31 is avoided.

Optionally, the support portion 35 may be located at a side of the conductive portion 33 facing the encapsulation portion 32. Alternatively, the support portion may further be located at a side of the conductive portion 33 away from the encapsulation portion 32.

In a second aspect, the embodiments of the present application further provide an antenna apparatus 200 including any one of the above antenna units 100.

Since the antenna apparatus 200 according to the embodiments of the present application includes the antenna unit 100 according to any one of the above embodiments, the antenna apparatus 200 according to the embodiments of the present application has the beneficial effects of the antenna unit 100 according to any one of the above embodiments, which are not repeated herein.

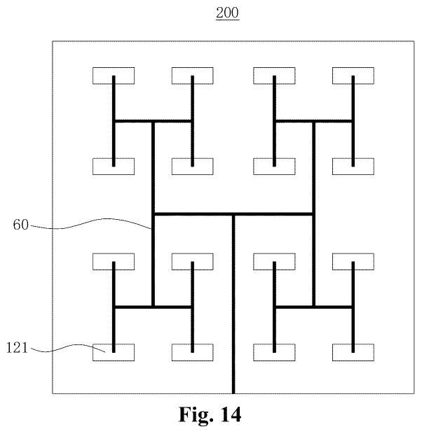

FIG. 14 is a schematic structural view of an antenna apparatus according to some embodiments of the present application.

As shown in FIG. 14, in some optional embodiments, the antenna apparatus 200 includes feeding lines 60 and a plurality of antenna units 100, the first substrate 10 of each antenna unit 100 is provided with the feeding line 60, and feeding layers 121 of the plurality of antenna units are electrically connected to the same radio frequency signal end by the feeding lines 60.

The feeding lines are configured to transmit the radio frequency signals from the radio frequency signal end to the feeding layers 121 of various phase shifting units P, thereby driving the liquid crystal molecules in the liquid crystal layer 30 to change, and achieving a precise phase adjustment to the electromagnetic wave.

Within the same antenna unit 100, the feeding layers 121 of the plurality of phase shifting units P are electrically connected to the same radio frequency signal end by the feeding lines 60. Such design ensures that all phase shifting units P can perform a phase adjustment synchronously after the same radio frequency signal is received, so that an overall control over the electromagnetic wave radiation characteristics is achieved by the antenna units 100.

In the embodiments of the present application, through the above arrangement, the radio frequency signals can be received and processed by the plurality of phase shifting units P within each antenna unit 100 synchronously, and the phase adjustment can be performed through respective liquid crystal layers 30, so that the overall control over the radio frequency signal radiation characteristics of the antenna units 100 is achieved, and flexibility and efficiency of the antenna apparatus 200 are improved.

In some optional embodiments, the antenna apparatus 200 includes the plurality of antenna units 100 and further includes control signal lines 70 and liquid crystal driving circuits 80, a plurality of control signal lines are provided on the first substrate 10, and the first electrode 13 of each phase shifting unit P of the same antenna unit 100 is connected to the liquid crystal driving circuit 80 of the antenna unit 100 by one of the control signal lines 70.

In the embodiments of the present application, the above arrangement is conducive to achieving a precise control and an independent adjustment of each phase shifting unit P, and improving the flexibility and accuracy of the antenna apparatus 200.

In a third aspect, the embodiments of the present application further provide an electronic device including any one of the above antenna apparatus 200.

Since the electronic device according to the embodiments of the present application includes the antenna apparatus 200 according to any one of the above embodiments, the electronic device according to the embodiments of the present application has the beneficial effects of the antenna apparatus 200 according to any of the above embodiments, which are not described in detail herein.

Although the present application has been described with reference to the preferred embodiments, various modifications can be made thereto and components thereof can be replaced with their equivalents without departing from the scope of the present application. In particular, various technical features described in various embodiments can be combined in any manner as long as there is no structural conflict. The present application is not limited to the specific embodiments described herein, and includes all technical solutions that fall within the scope of the claims.

What is claimed is:

1. An antenna unit, comprising:
a first substrate comprising a first base, a feeding unit and a first electrode, the feeding unit and the first electrode being disposed at two opposite sides of the first base, the feeding unit being electrically connected to a radio frequency signal end, the first electrode being electrically connected to a control signal line, and along a direction perpendicular to a plane where the first substrate is located, the feeding unit at least partially overlapping the first electrode;
a second substrate comprising a second base, a radiation unit and a second electrode, the second electrode being located at a side of the second base facing the first substrate, the second electrode being electrically connected to a ground signal end, the radiation unit being disposed on the second base and insulated from the second electrode, and along the direction perpendicular to the plane where the first substrate is located, the first electrode overlaps the radiation unit and the second electrode respectively; and
a liquid crystal layer located between the first substrate and the second substrate.

2. The antenna unit according to claim 1, wherein the feeding unit is connected to the first base by a first adhesion layer.

3. The antenna unit according to claim 2, wherein the first adhesion layer comprises a plurality of first adhesion portions disposed at intervals, and along the direction perpendicular to the plane where the first substrate is located, the first adhesion portion is spaced apart from an overlapping area of the feeding unit and the first electrode.

4. The antenna unit according to claim 2, wherein the first adhesion layer entirely covers the feeding unit.

5. The antenna unit according to claim 1, wherein the radiation unit is located at a side of the second base away from the first substrate, the radiation unit comprises a radiation body and a third base, the radiation body is located at a side of the third base away from the second base, and the third base is connected to the second base by a second adhesion layer.

6. The antenna unit according to claim 5, wherein the second adhesion layer entirely covers the second base; or,
the second adhesion layer comprises a plurality of second adhesion portions disposed at intervals, and along the direction perpendicular to the plane where the first substrate is located, the second adhesion portion is spaced apart from the radiation body.

7. The antenna unit according to claim 1, wherein the feeding unit comprises a feeding layer, a shielding layer and a fourth base located between the feeding layer and the shielding layer, the shielding layer is electrically connected to the ground signal end, and the shielding layer is provided with a first opening; along the direction perpendicular to the plane where the first substrate is located, the first opening, the feeding layer and the first electrode at least partially overlap with one another.

8. The antenna unit according to claim 7, wherein the radiation unit is disposed at a side of the second base away from the first substrate, the radiation unit comprises a radiation body, the second electrode is provided with a second opening, and along the direction perpendicular to the plane where the first substrate is located, the second opening, the radiation body and the first electrode at least partially overlap with one another.

9. The antenna unit according to claim 8, wherein along the direction perpendicular to the plane where the first substrate is located, the first opening at least partially overlaps the second opening; or,
along the direction perpendicular to the plane where the first substrate is located, the second opening is located within the first opening.

10. The antenna unit according to claim 7, wherein the shielding layer comprises a main body portion and a protruding portion, the protruding portion protrudes from the main body portion along a direction from the fourth base to the first base, the protruding portion encloses the first opening, and a first adhesion layer covers at least the main body portion.

11. The antenna unit according to claim 10, wherein a gap is provided between the protruding portion and the first base.

12. The antenna unit according to claim 1, wherein the antenna unit comprises a plurality of phase shifting units arranged in an array, each of the phase shifting units comprises the feeding unit, the first electrode, the radiation unit, the second electrode and the liquid crystal layer, the first adhesion portion is provided between at least a part of the adjacent phase shifting units of the plurality of phase shifting units, and the first adhesion portion is provided between the feeding unit and the first base.

13. The antenna unit according to claim 12, wherein the phase shifting units are arranged in rows along a first direction and in columns along a second direction;
each of the first adhesion portions are provided between two adjacent columns of the phase shifting units; or,
each of the first adhesion portions are provided between two adjacent rows of the phase shifting units.

14. The antenna unit according to claim 12, wherein the first adhesion portions extend along a first direction, and a plurality of the phase shifting units are provided at two sides of each of the first adhesion portions along a second direction respectively; or,
the first adhesion portions extend along the second direction, and a plurality of the phase shifting units are provided at two sides of each of the first adhesion portions along the first direction respectively.

15. The antenna unit according to claim 1, wherein the feeding unit comprises a feeding layer, the radiation unit comprises a radiation body, the first electrode comprises a first sub-electrode and a second sub-electrode, the first sub-electrode is electrically connected to the control signal line, and along the direction perpendicular to the plane where the first substrate is located, the second sub-electrode overlaps the feeding layer and the radiation body respectively.

16. The antenna unit according to claim 15, wherein the first sub-electrode is electrically connected to the second sub-electrode.

17. The antenna unit according to claim 16, wherein the first sub-electrode is insulated from the second sub-electrode, and at least a part of the first sub-electrode is located at a side of a part of the second sub-electrode away from the first base.

18. An antenna apparatus, comprising an antenna unit, wherein
the antenna unit comprises:
a first substrate comprising a first base, a feeding unit and a first electrode, the feeding unit and the first electrode being disposed at two opposite sides of the first base, the feeding unit being electrically connected to a radio frequency signal end, the first electrode being electrically connected to a control signal line, and along a direction perpendicular to a plane where the first substrate is located, the feeding unit at least partially overlapping the first electrode;
a second substrate comprising a second base, a radiation unit and a second electrode, the second electrode being located at a side of the second base facing the first substrate, the second electrode being electrically connected to a ground signal end, the radiation unit being disposed on the second base and insulated from the second electrode, and along the direction perpendicular to the plane where the first substrate is located, the first electrode overlaps the radiation unit and the second electrode respectively; and
a liquid crystal layer located between the first substrate and the second substrate.

19. The antenna apparatus according to claim 18, wherein the antenna apparatus comprises feeding lines, and a plurality of the antenna units are provided, the first substrate of each of the antenna units is provided with the feeding line, and feeding layers of a plurality of the phase shifting units of each of the antenna units are electrically connected to each radio frequency signal end by the feeding lines.

20. An electronic device comprising an antenna apparatus, wherein
the antenna apparatus comprises an antenna unit,
the antenna unit comprising:
a first substrate comprising a first base, a feeding unit and a first electrode, the feeding unit and the first electrode being disposed at two opposite sides of the first base, the feeding unit being electrically connected to a radio frequency signal end, the first electrode being electrically connected to a control signal line, and along a direction perpendicular to a plane where the first substrate is located, the feeding unit at least partially overlapping the first electrode;
a second substrate comprising a second base, a radiation unit and a second electrode, the second electrode being located at a side of the second base facing the first substrate, the second electrode being electrically connected to a ground signal end, the radiation unit being disposed on the second base and insulated from the second electrode, and along the direction perpendicular to the plane where the first substrate is located, the first electrode overlaps the radiation unit and the second electrode respectively; and
a liquid crystal layer located between the first substrate and the second substrate.
